(19) United States
(12) Patent Application Publication
(10) Pub. No.: US 2012/0174029 A1
(43) Pub. Date: Jul. 5, 2012

(54) DYNAMICALLY MAGNIFYING LOGICAL SEGMENTS OF A VIEW

(75) Inventors: Paul R. Bastide, Boxford, MA (US); Matthew E. Broomhall, South Burlington, VT (US); Jose L. Lopez, Austin, TX (US); Robert E. Loredo, North Miami Beach, FL (US); Andrew L. Schirmer, Andover, MA (US)

(73) Assignee: International Business Machines Corporation, Armonk, NY (US)

(21) Appl. No.: 12/982,418

(22) Filed: Dec. 30, 2010

(51) Int. Cl. G06F 3/048

(52) U.S. Cl. 715/800

(57) ABSTRACT

Exemplary embodiments disclose a method and system for dynamically magnifying logical segments of a view. The method and system include (a) in response detection of a first user gesture in a first location on a display screen, determining if the first user gesture represents a magnification event; (b) in response to detection of the magnification event, determining a shape of a first object displayed on the display screen within proximity of the first user gesture; (c) magnifying the shape of the first object to provide a magnified first object; (d) displaying the magnified first object in a first window over the first object; and (e) in response to detection of a second user gesture in a different location of the display screen, repeating steps (a) through (d) to magnify a second object and display the second object in a second window simultaneously with the first window. A further embodiment may include dynamically magnifying the magnified first object to various magnification levels.

### BACKGROUND

Most software applications today provide a zoom function or magnification mode that enables a user to zoom in or out of a page, or to magnify an object in a page or view. For example, it is common for word processors and web browsers to include a user selectable zoom level whereby the user can zoom in and out of a page by moving a zoom level slider bar, such as in Microsoft Word™, or by pressing Ctrl + or Ctrl −, such as in the Firefox™ web browser. On touch screen enabled-devices, the zoom function may be activated by a user's fingers in a manner referred to a “pinch zoom”, such as on Apple Computer's iPhone™ and iPad™.

Rather than zooming an entire page, the magnification mode enables a user to magnify all or part of an object displayed in the page or view. Typically, the user may magnify an image by placing a cursor over the object and doubling clicking the image, or hovering the cursor over a “view” icon associated with the object. The object may then be displayed as a larger view in a magnification window that is displayed over the page or view.

Although both the zoom levels and magnification modes effectively enlarge a displayed object, other objects the user may wish to also view may be either zoomed out of view when the entire page or view is zoomed, or are obscured by the magnification window.

Accordingly, a need exists for an improved method and system for dynamically magnifying logical segments of a view.

### BRIEF SUMMARY

Exemplary embodiments disclose a method and system for dynamically magnifying logical segments of a view. The method and system include (a) in response detection of a first user gesture in a first location on a display screen, determining if the first user gesture represents a magnification event; (b) in response to detection of the magnification event, determining a shape of a first object displayed on the display screen within proximity of the first user gesture; (c) magnifying the shape of the first object to provide a magnified first object; (d) displaying the magnified first object in a first window over the first object; (e) in response to detection of a second user gesture in a different location of the display screen, repeating steps (a) through (d) to magnify a second object and display the second object in a second window simultaneously with the first window. A further embodiment may include dynamically magnifying the magnified first object to various magnification levels.

### BRIEF DESCRIPTION OF THE DRAWINGS

FIG. 1 is a logical block diagram illustrating an exemplary system environment for implementing one embodiment of dynamic magnification of logical segments of a view.

FIG. 2 is a diagram illustrating a process for dynamically magnifying logical segments of a view according to an exemplary embodiment.

FIGS. 3A-3C are diagrams graphically illustrating the process of dynamically magnifying logical segments of a view.

### DETAILED DESCRIPTION

The present invention relates to methods and systems for dynamically magnifying logical segments of a view. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The exemplary embodiments provide methods and systems for dynamically magnifying logical segments of objects displayed in one or more views. The exemplary embodiments react to detected user gestures to automatically magnify the logical segments of the objects on which the user has gestured to create multiple magnified views of the logical segments and at varying levels of magnification based on the type or timing of the gesture. Having multiple magnification windows open at the same time enables the user to view multiple magnified objects at one time for easy comparison.

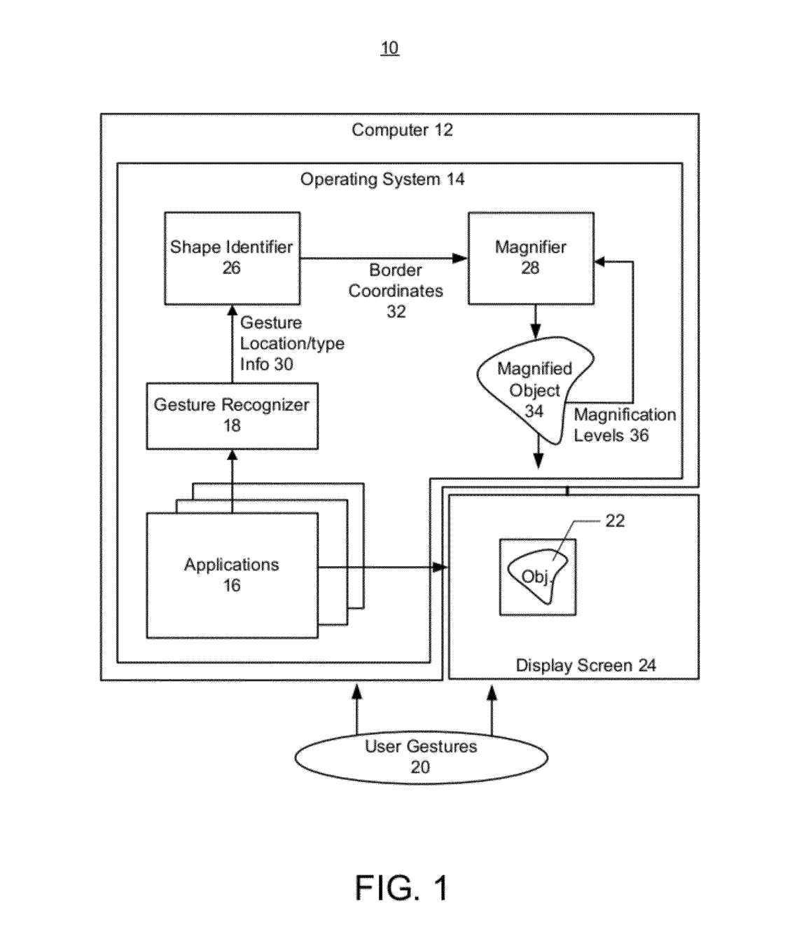

FIG. 1 is a logical block diagram illustrating an exemplary system environment for implementing one embodiment of dynamic magnification of logical segments of a view. The system 10 includes a computer 12 having an operating system 14 capable of executing various software applications 16. The software applications 16 may be controlled by a user with pointing devices, such as a mouse or stylus, and/or may be touch screen enabled, which enables the applications be used with a variety of pointing devices, including the user's finger and various types of styluses.

A conventional gesture recognizer 18, which may be at part of the operating system 14 or incorporated into the applications 16, may receive user gestures 20 associated with the applications 16 and determine a gesture location and a gesture type, e.g., a double mouse click or a pinch and zoom.

During operation, the software applications 16 (such as a web browser, a word processor, a photo/movie editor, and the like) display objects 22 including images, text and icons on a display screen 24 in a view, page, or video. Regardless of the types of objects 22 displayed, the object 22 can be described as comprising logical segments of letters, borders, edges, image data, and so on. During viewing, a user may wish to magnify some or all of the logical segments comprising the objects 22.

Accordingly, the exemplary embodiment provides a shape identifier 26 module and a magnifier 28 module. The shape identifier 26 module may be configured to receive gesture location and gesture type information 30 from the gesture recognizer 18. In one embodiment, the shape identifier 26 module determines if the gesture type represents a magnification event. In an alternative embodiment, the gesture recognizer 18 may be configured to determine if the user gesture 20 represents a magnification event and to pass the gesture location to the shape identifier 26 module. In response to detection of a magnification event, the shape identifier 26 module determines the edge boundaries of an object displayed on the display screen 24 in proximity to the gesture location to determine the shape of the object 22.

The magnifier 28 module receives border coordinates 32 of the object 22 from the shape identifier 26 module and magnifies the logical segments within the border coordinates of the object 22 to produce a magnified object 34. The magnifier 28 module then displays the magnified object 34 in a separate window on the display screen 24 over the original object 22. This window may be moved by the user so the user may view both the original object 22 and the magnified object 34.

According to one aspect of the exemplary embodiment, the shape identifier 26 module and the magnifier 28 module may be configured to dynamically magnify and display the magnified object 34 with various magnification levels 36 in response to detecting a single or multiple magnification events on the object 22 and/or the magnified object 34.

According to another aspect of the exemplary embodiment, the shape identifier 26 module and the magnifier 28 module may be configured to receive multiple magnification events performed on multiple objects 22, and in response, produce corresponding multiple magnified objects 34 that are displayed in multiple windows on the display screen 24 at the same time. Each of the magnified objects 34 may be further magnified.

Although a shape identifier 26 and magnifier 28 module have been described for implementing the exemplary embodiments, the functionality provided by these modules may be combined into more modules or a less number of modules, or incorporated into the application 16 or operating system 14.

The computer 12 may exist in various forms, including a personal computer (PC), (e.g., desktop, laptop, or notebook), a smart phone, a personal digital assistant (PDA), a set-top box, a game system, and the like. The computer 12 may include modules of typical computing devices, including a processor, input devices (e.g., keyboard, pointing device, microphone for voice commands, buttons, touch screen, etc.), output devices (e.g., a display screen). The computer 12 may further include computer-readable media, e.g., memory and storage devices (e.g., flash memory, hard drive, optical disk drive, magnetic disk drive, and the like) containing computer instructions that implement an embodiment of dynamic magnification of logical segments of a view when executed by the processor.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

The input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

In another embodiment, the shape identifier 26 and magnifier 28 module may be implemented in a client/server environment, where the shape identifier 26 and magnifier 28 module are run on the server and provide the magnified objects to the client for display.

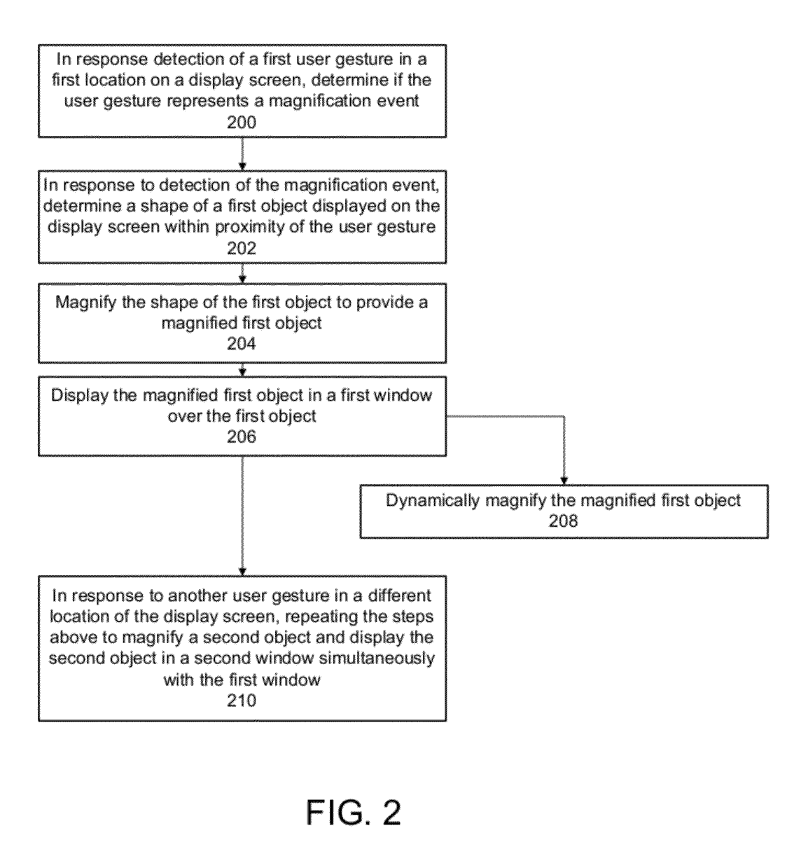

FIG. 2 is a diagram illustrating a process for dynamically magnifying logical segments of a view according to an exemplary embodiment. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The process may include responding to detection of a first user gesture in a first location on a display screen by determining if the user gesture represents a magnification event (step 200).

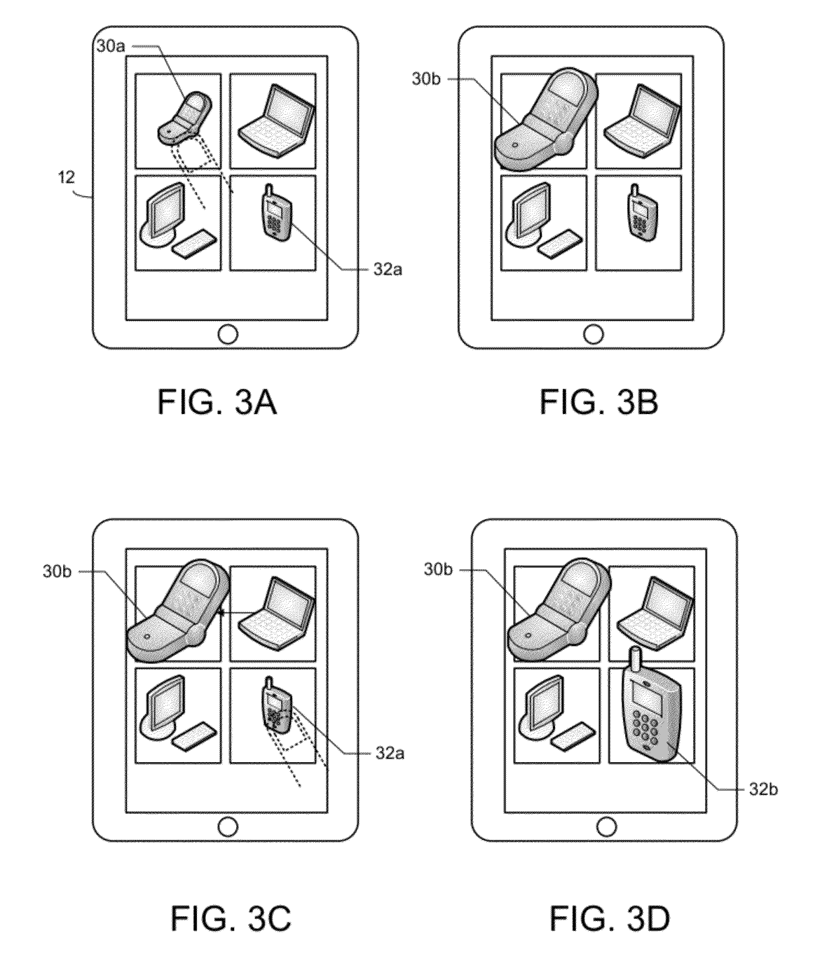

FIGS. 3A-3C are diagrams graphically illustrating the process of dynamically magnifying logical segments of a view. FIGS. 3A-3C, a computer 12, such as tablet computer, is shown displaying a variety of objects on the tablet screen, including object 30a and object 32a. In FIG. 3A, the user performs a user gesture with a finger (shown by the dashed lines) that represents a magnification event over object 30a.

In one embodiment, a variety of user gestures 20 may be used to represent a magnification event. For example, a single or double mouse click or finger press and hold could represent a magnification event, as could a finger pinch and zoom gesture made on a target area of the display screen 24. Other examples include a finger tap and hold or a circular motion made with a mouse or finger around an area of the display screen 24. As described above, either the gesture recognizer 18 or the shape identifier 26 may be configured to detect a magnification event from the type of gesture performed.

Referring again FIG. 2, in response to detection of the magnification event, the shape identifier 26 module determines a shape of a first object that is displayed on the display screen within proximity of the user gesture (step 202). In one embodiment, the gesture recognizer 18 passes coordinates of the gesture location to the shape identifier 26. The shape identifier 26 module may then determine the shape of the object that is displayed directly underneath the location of the user gesture 20. However, in alternative embodiment, the shape identifier 26 module may determine shapes of objects within a configurable distance from the user gesture 20.

In one embodiment, the shape identifier 26 module may determine the shape of the object 22 displayed on the display screen 24 by capturing an image of content currently displayed on the display screen, converting an image into a two-dimensional array of values, such as RGB integer values, and determining an edge boundary defining the shape of the object. In FIG. 3A for example, the shape identifier 26 module may determine the shape of object 30a by determining the edge boundaries defining the shape. Determining the edge boundaries of an object can be performed a variety of well-known techniques.

If the object is displayed in a video, then the shape identifier 26 module may have a conventional frame grab performed on the video to capture individual, digital still frames from an analog video signal or a digital video stream.

In one embodiment, the shape identifier 26 module may be configured to determine the shape of an object by determining if the object is text or image data. If the object is text, the shape identifier 26 module may define a border around the text that has edge boundaries of a predefined size and shape. For example, the shape identifier 26 module may determine maximum X and Y coordinates from the detected location of the magnification event and draw a border, such as a rectangle, square, oval, or circle around the text based on the maximum X and Y coordinates. A simple background could be included within the border to provide contrast for the text object.

After the shape identifier 26 module determines the shape of the first object, the shape identifier 26 module passes the border coordinates 32 of the shape to the magnifier 28 module. The magnifier 28 module then magnifies the shape of the first object to provide a magnified first object (block 204). In one embodiment, various types of magnification options may be used, such as bicubic or doubling the pixels, based on system performance trade-offs.

The magnifier 28 module also displays the magnified object in a first window over the first object (block 206).

FIG. 3B shows the result of object 30a being magnified and displayed as a magnified object 30b. In one embodiment, the magnified object 30b is displayed in a transparent window over the original object 30a so that just the magnified object 30b is viewable. In an alternative embodiment, the magnified object 30b could be displayed in a non-transparent window that includes a background. In one embodiment, the user may end the magnification event and close the window by performing a particular type of user gesture, such as pressing the escape key.

Referring again to FIG. 2, the magnifier 28 module may dynamically magnify the magnified first object to various magnification levels 36 (block 208). In one embodiment, the object is magnified in response to detection of the original magnification event, such as a finger press and hold on the original object where holding down the finger may resolve to further magnification levels 36 up or down and the user my lift the finger when a desired magnification level is reached. In one embodiment, the magnifier 28 module may include configurable thresholds for controlling the magnification factors and times that the magnification levels 36 are displayed. The thresholds may be different for different types of selection algorithms and magnification levels 36.

In another embodiment, the object may be dynamically magnified in response to another user gesture, such as a tap, or point and click, that is detected on the magnified object. By repeatedly performing a magnification gesture on the magnified object, the user may cause the magnifier 28 module to magnify and display the magnified object at various magnification levels 36. In addition, the logical segments displayed in the window may be magnified or only the logical segments within a predefined boundary may be magnified.

In response to detection of a another user gesture in a different location of the display screen, the steps above are repeated to magnify a second object and to display the second object in a second window simultaneously with the first window (block 210).

FIG. 3C shows the user moving a finger to a different location of the display screen and performing a magnification gesture over object 32a, while magnified object 30b is still displayed. In response, the system 10 magnifies object 32a and displays another magnified object 32b in a separate window over original object 32a. As shown, the system 10 is capable of simultaneously displaying multiple magnified objects 30b and 32b for easy comparison by the user.

A system and method for dynamically magnifying logical segments of a view have been disclosed. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A computer-implemented method for dynamically magnifying logical segments of a view, comprising:
(a) in response detection of a first user gesture in a first location on a display screen, determining if the first user gesture represents a magnification event;
(b) in response to detection of the magnification event, determining a shape of a first object displayed on the display screen within proximity of the first user gesture;
(c) magnifying the shape of the first object to provide a magnified first object;
(d) displaying the magnified first object in a first window over the first object; and
(e) in response to detection of a second user gesture in a different location of the display screen, repeating steps (a) through (d) to magnify a second object and display the second object in a second window simultaneously with the first window.

2. The method of claim 1 further comprising:
dynamically magnifying the magnified first object to various magnification levels.

3. The method of claim 1 wherein determining if the first user gesture represents a magnification event further comprises detecting at least one of a finger press and hold and a mouse click on the display screen.

4. The method of claim 1 further comprising, in response to determining that the first user gesture represents a magnification event, determining a location of the user gesture on the display screen.

5. The method of claim 1 wherein determining the shape of an object displayed on the display screen within proximity of the first user gesture further comprises determining the shape of an object displayed on the display screen underneath the first user gesture.

6. The method of claim 1 wherein determining the shape of an object displayed on the display screen further comprises:
determining if the object is text or image data; and
defining a border around the text having edge boundaries of a predefined size and shape.

7. The method of claim 1 wherein dynamically magnifying the magnified first object further includes configurable thresholds for controlling magnification factors and times that magnification levels are displayed.

8. An executable software product stored on a computer-readable medium containing program instructions for dynamically magnifying logical segments of a view, the program instructions for:
(a) in response detection of a first user gesture in a first location on a display screen, determining if the first user gesture represents a magnification event;
(b) in response to detection of the magnification event, determining a shape of a first object displayed on the display screen within proximity of the first user gesture;
(c) magnifying the shape of the first object to provide a magnified first object;
(d) displaying the magnified first object in a first window over the first object; and
(e) in response to detection of a second user gesture in a different location of the display screen, repeating steps (a) through (d) to magnify a second object and display the second object in a second window simultaneously with the first window.

9. The executable software product of claim 8 further comprising program instructions for:
dynamically magnifying the magnified first object to various magnification levels.

10. The executable software product of claim 8 wherein determining if the first user gesture represents a magnification event further comprises detecting at least one of a finger press and hold and a mouse click on the display screen.

11. The executable software product of claim 8 further comprising program instructions for, in response to determining that the first user gesture represents a magnification event, determining a location of the first user gesture on the display screen.

12. The executable software product of claim 8 wherein determining the shape of an object displayed on the display screen within proximity of the first user gesture further comprises determining the shape of an object displayed on the display screen underneath the first user gesture.

13. The executable software product of claim 8 wherein determining the shape of an object displayed on the display screen further comprises:
determining if the object is text or image data; and
defining a border around the text having edge boundaries of a predefined size and shape.

14. The executable software product of claim 8 wherein dynamically magnifying the magnified first object further includes configurable thresholds for controlling magnification factors and times that magnification levels are displayed.

15. A system comprising:
a computer comprising a memory, processor and a display screen;
a gesture recognizer module executing on the computer, the gesture recognizer module configured to receive a user gesture and determine a gesture location and gesture type;
a shape identifier module executing on the computer, the shape identifier module configured to:
receive the gesture location and gesture type from the gesture recognizer module;
determine if the gesture type represents a magnification event; and
in response to detection of the magnification event, determine an edge boundary of an object displayed on the display screen beneath the gesture location to determine the shape of the object; and
a magnifier module executing on the computer, the magnifier module configured to:
receive border coordinates of the object from the shape identifier module and magnify logical segments within the border coordinates of the object to produce a magnified object; and
display the magnified object in a separate window on the display screen over the original object; and
wherein the shape identifier module and the magnifier module are further configured to:
detect multiple magnification events performed on multiple objects displayed on the display screen, and in response, produce corresponding multiple magnified objects that are displayed in multiple windows on the display screen at the same time.

16. The system of claim 15 wherein the shape identifier module and the magnifier module are further configured to:
dynamically magnify and display the magnified object in the window with various magnification levels.
